(19) United States
(12) Patent Application Publication
(10) Pub. No.: US 2010/0320938 A1
(43) Pub. Date: Dec. 23, 2010

(54) METHOD OF DRIVING A GAS-DISCHARGE LAMP

(75) Inventors: Jens Pollmann-Retsch, Aachen (DE); Uwe Mackens, Aachen (DE); John-John Pieter Jan Vav Den Bergh, Turnout (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/918,086

(22) PCT Filed: Feb. 13, 2009
(86) PCT No.: PCT/IB09/50593

§ 371 Date: Aug. 18, 2010

(30) Foreign Application Priority Data
Feb. 25, 2008 (EP) 08101929.1

(51) Int. Cl. H05B 41/36

(52) U.S. Cl. 315/307

(57) ABSTRACT

The invention describes a method of driving a gas-discharge lamp (1), wherein the lamp (1) is driven at any one time using one of a number of driving schemes and wherein the operating voltage of the lamp (1) is monitored to obtain a number of operation data values (D) during operation of the lamp (1), a target voltage (VT) is determined on the basis of at least one of the number of operation data values (D), and a driving scheme switch-over occurs according to a relationship between the target voltage (VT) and the operating voltage of the lamp (1). The invention further describes a driving unit (10) for driving a gas-discharge lamp (1) comprising a voltage monitoring unit (12) for monitoring the operating voltage of the lamp (1) to obtain a number of operation data values during operation of the lamp (1); a target voltage determination unit (13) for determining a target voltage (VT) on the basis of at least one of the number of operation data values, and a driving scheme switching unit (14) for switching from a first driving scheme to a second driving scheme according to a relationship between the target voltage (VT) and the operating voltage of the lamp (1).

### FIELD OF THE INVENTION

The invention describes a method of driving a gas-discharge lamp, and a driving unit for driving a gas-discharge lamp.

### BACKGROUND OF THE INVENTION

In gas discharge lamps such as HID (High Intensity Discharge) and UHP (Ultra-High Pressure) lamps, a bright light is generated by a discharge are spanning the gap between two electrodes disposed at opposite ends of a discharge chamber of the lamp. In short-arc and ultra-short-arc discharge lamps, the electrodes in the discharge chamber are separated by only a very short distance, for example one millimetre or less. The discharge arc that spans this gap during operation of the lamp is therefore also short, but of intense brightness. Such lamps are useful for applications requiring a bright, near point source of white light, for example in image projection applications or in automotive headlights.

When such a lamp is driven using alternating current (AC), each of the electrodes functions alternately as anode and cathode, so that the discharge arc alternately originates from one and then the other electrode. Ideally, the arc would always attach to the electrode at the same point, and would span the shortest possible distance between the two electrode tips. However, because of the high temperatures that are reached during AC operation at high voltages, the electrodes of a gas-discharge lamp are subject to physical changes, i.e. an electrode tip may melt or burn back, and structures may grow at one or more locations on the electrode tip at the point where the arc attaches to the tip. Such physical alterations to the electrode can adversely affect the brightness of the arc, since the arc may become longer or shorter, leading to fluctuations in the light output (flux) of the lamp. In the case of an automotive application such as a headlamp, it is important for obvious reasons that the light output is not subject to unpredictable variations. In an image projection system, such alterations in the light output may even be noticeable to the user, an effect which is evidently undesirable.

Therefore, a stable arc length is of utmost importance in projection applications. Maintaining the light flux in modern projectors ultimately means maintaining a short arc-length for prolonged times. The arc length is directly related to the operating voltage of the lamp. This known relationship is used in some approaches to the problem, for example by switching between dedicated lamp driving schemes when the operating voltage reaches a predefined voltage target value. The lamp driving schemes serve to stabilise the arc length, and may include sophisticated combinations of different current wave shapes and operating frequencies, designed so that alterations to the electrode tips are avoided where possible, or that the growing and melting of structures on the electrodes occur in a controlled manner. Depending on the choice of lamp driving scheme, modifications to the electrode surface can take effect within short to very short timescales.

A state of the art driver for such a lamp is described in WO 2005/062684 A1 which is incorporated herein by reference and which describes a method in which a target voltage is predefined and the lamp driver uses the predefined value to decide when to switch between driving schemes or modes of operation with specific combinations of different current wave-shapes and operating frequencies, for instance whenever the observed operating voltage of the lamp crosses the target voltage value or deviates by a predefined amount from the target voltage value. In a first mode of operation, controlled growing of structures on the lamp's electrodes is achieved by means of a known block shape of the lamp current upon which current-pulses are superimposed, directly preceding a commutation of the current. In a second mode of operation, a controlled melting back of the electrode front faces is achieved by driving the lamp at a higher frequency than in the first mode and without such a current-pulse superimposed on the current wave shape directly preceding the commutation of the current.

The predefined target voltage for a lamp series is determined for example during experiments carried out for a particular lamp type during the development stage. The target voltage can then be stored, for example in a memory of the lamp driver for use during operation of the lamp.

However, because of unavoidable production spread, the physical properties of individual lamps of a production series will not always be exactly the same and can in fact be subject to considerable discrepancies. Therefore, a predefined voltage target that provides good results for some lamps in a series may fail to achieve the desired quality of operation for the remaining lamps. Furthermore, physical lamp properties can change over time as the lamp ages with use, so that a lamp that has operated satisfactorily for the first few hundred hours of lamp life may thereafter exhibit a drop in performance as a result of its ageing. In both cases, the lamp is not driven optimally. This may be perceptible to the user as an unsatisfactory light flux. Furthermore, the electrodes may deteriorate as a result of the incorrect driving, and this in turn can ultimately lead to failure of the lamp.

Therefore, it is an object of the invention to provide an improved way of driving a short-arc lamp of the type described above that circumvents the problems mentioned above.

### SUMMARY OF THE INVENTION

To this end, the present invention describes a method of driving a gas-discharge lamp, wherein the lamp is driven at any one time using one of a number of driving schemes and the operating voltage of the lamp is monitored to obtain a number of operation data values during operation of the lamp, a target voltage is determined on the basis of at least one of the number of operation data values, and a driving scheme switch-over occurs according to a relationship between the target voltage and the operating voltage of the lamp.

The target voltage, as already indicated above, is the voltage level upon which a driver of the lamp bases its decision to switch from one driving scheme to another. An obvious advantage of the method according to the invention is that a target voltage can be determined precisely for a particular lamp, so that the quality of operation of the lamp is not dependent on a target voltage common to all lamps of a production series. Variations in properties of the lamps of a production series arising due to unavoidable aberrations in the production process will not result in fluctuations in quality, but can be successfully compensated for each individual lamp. A lamp driven using the method according to the invention is no longer dependent on some pre-set or fixed value of voltage target that may in fact be unsuitable for that particular lamp.

Using the method according to the invention, the correct instant at which a driving scheme switch-over should be made can be precisely identified during operation. By always driving the lamp with the most suitable driving scheme for each phase in its operation advantageously ensures that desired physical alterations to the electrodes can be prompted in a particularly well-controlled manner, so that the arc length and therefore also the light flux of the lamp can be maintained in an optimal manner.

An appropriate driving unit for driving a gas-discharge lamp comprises a monitoring unit for monitoring the operating voltage of the lamp to obtain a number of operation data values during operation of the lamp, a target voltage determination unit for determining a target voltage on the basis of at least one of the number of operation data values, and a driving scheme switching unit for switching from a first driving scheme to a second driving scheme according to a relationship between the target voltage and the operating voltage of the lamp.

The dependent claims and the subsequent description disclose particularly advantageous embodiments and features of the invention.

The operation data value obtained at some point in time during operation of the lamp can be the value of any parameter that is suitable for describing the momentary behaviour of the lamp. For example, a value of current or voltage or lamp power could be used. However, the most suitable parameter is generally the operating voltage of the lamp. Therefore, in the following, but without restricting the invention in any way, it is assumed that an operation data value obtained at a certain point in time comprises the operating voltage of the lamp at that point in time.

The instant in time at which the lamp driver causes a driving scheme switch-over to take place is determined by the behaviour of the operating voltage with respect to the target voltage value. In a particularly preferred embodiment of the invention, a driving scheme switch-over is triggered when the operating voltage crosses the target voltage value, i.e. when the operating voltage has dropped from a value higher than the target voltage value to a value lower than the target voltage value, or vice versa. The choice of driving scheme to apply can depend also on the direction of crossing, i.e. whether the operating voltage crosses the target voltage value from above (operating voltage is dropping) or from below (operating voltage is increasing).

In a particularly straightforward embodiment of the invention, an operation data value is obtained at a predefined point in time during operation of the lamp. For example, the operating voltage can be measured at a certain predefined duration after the lamp has been switched on, for example five minutes after switch-on. Alternatively, the operating voltage can be measured when run-up is completed. Equally, the momentary operating voltage can be measured when the lamp-driver receives the switch-off signal from the user, for example via a remote control, so that the operating voltage is measured at a predefined point in time before run-down. The meaning of the terms ‘run-up’ and ‘run-down’ will be known to a person skilled in the art. ‘Run-up’ is the phase directly after the lamp has been switched on and during which the lamp parameters such as temperature, voltage etc. approach their operating levels, while ‘run-down’ is the phase following a signal to extinguish the lamp, in which the lamp is driven in a controlled manner until parameters of the lamp indicate that it can be extinguished without any detrimental effects such as blackening. The time between switching on the lamp and switching it off again is referred to as the ‘switching cycle’ of the lamp.

Obtaining the operation data value at such predefined points in time can be appropriate for lamps that are used for comparatively short durations. However, when a lamp is operating for much longer durations, several tens or hundreds of hours, the method according to the invention allows the voltage target to be determined on a recurring basis. In a preferred embodiment of the invention, therefore, a plurality of operation data values are obtained at intervals during operation of the lamp, and the target voltage is dynamically adjusted according to the obtained operation data values. In this way, the target voltage can be adjusted periodically to compensate for an overall increase or overall decrease in the operating voltage over time. In other words, the target voltage can follow a trend of the operating voltage, so that, if the operating voltage is showing a tendency to increase over time, the target voltage can be stepped up accordingly, or, if the operating voltage tends to decrease over time, the target voltage can be stepped down as appropriate. Such a dynamic adjustment of the voltage target level can be carried out at intervals, periodically or sporadically, depending on the lamp or on its behaviour during operation.

Operation data values and the determined target voltage value can be stored in a non-volatile memory so that these values are always available during a switching cycle of the lamp, but also so that the values can be used in a subsequent switching cycle. In this way, it is possible to keep track of the voltage history over lamp switching cycles. For example, in a simple approach, the operating voltage value measured at a certain predefined time before switching off the lamp is stored in a non-volatile memory, and used in the next switching cycle of the lamp.

In a particularly preferred embodiment of the invention, the target voltage is derived from an average or mean of a plurality of operation data values collected over time. For example, a series of operating voltage values can be collected at intervals, such as once every hour, once every five minutes, etc. The average of these operating voltage values can be calculated, and the result can be used as the target voltage. A ‘moving average’ could also be calculated, which moving average better follows the actual operating conditions of the lamp, for example by disregarding the oldest values, for example values obtained more than five hours previously.

The rate at which the operating voltage is measured, for instance every five minutes, every hour, etc., can be adjusted dynamically as well. For instance, observation of the operation data values may show that these change only very slowly over time. In such a case, it may be sufficient to collect an operation data value only every hour or so, and the target voltage need also only be adjusted over relatively large time intervals. However, for a lamp whose operating voltage is subject to more fluctuation, it may be desirable to adjust the target voltage more often. Furthermore, a limit can be set as to how many operation data values are used in determining the target voltage, i.e. how much of the operating history of the lamp should be taken into account. For instance, it may suffice to use the previous twenty values, or it may be preferred to use the previous hundred stored values. Values dating further back can then simply be disregarded, or overwritten in the non-volatile memory.

In a further preferred embodiment, a previous target voltage can be used in combination with one or more values of operating voltage to determine a new value of target voltage. For example, a different type of ‘average’ can be obtained by adding the momentary operating voltage value to the momentary voltage target and taking half this value as the new voltage target. This simple algorithm naturally takes into account the operation history of the lamp, while at the same time emphasizing the most recent data points. Furthermore, this algorithm also minimises memory and computational requirements since it does not require storing the entire voltage history in memory.

The method according to the invention also allows a target voltage value to be adjusted according to a ‘desired’ target voltage value for that lamp type. For example, an average or mean value of operating voltage, calculated using values collected during a the lamp switching cycle, can be adjusted by factoring in a ‘desired’ target voltage value, which can also be weighted by a predefined amount. This technique can be applied to adjust any target voltage determined using the techniques described here.

In a further variation, the deviations of the operating voltage from the present voltage target can be considered when deciding whether to determine a new target voltage. For example, a new value of target voltage may be computed as described above only when the deviations between observed operating voltage and present target voltage become too large, occur too frequently, or last too long. In this way, brief fluctuations in operating voltage will not have any effect on the target voltage, but a tendency on the part of the operating voltage to drift away from the target voltage will be recognised. While the averaging algorithm described above is one way to ensure a conditional change of the voltage target, other, more sophisticated, methods are conceivable. For example, the number of each type of deviation observed could be counted using an accumulator, or collected values could be processed by a filter to determine the bandwidth of the operating voltage variations. These more sophisticated approaches offer the advantage that the behaviour of the target voltage algorithm can be fine-tuned to give more optimal results.

In another version, instead of using an average value of the operating voltage values, the target voltage could be set to the highest or lowest value of operating voltage observed within a certain time interval. For example, the target voltage can be set to the highest value of operating voltage observed during the last 2 hours. By repeatedly adjusting the voltage target in this way, fluctuations in the operating voltage can be reduced, since the operating voltage will tend to be stabilised close to a value that it would reach anyway.

In a further development of this version, the overall trend of the operating voltage development may be analysed by the lamp-driver, and the trend may be used to decide whether the maximum or minimum operating voltage value within a certain time interval is to be used as the target voltage. For instance, if the observed values of operating voltage indicate an upwards trend, the maximum observed value will be used as the target voltage value, otherwise the minimum observed value will be used as the target voltage value. As will be appreciated by a person skilled in the art, this approach requires that the choice of time interval between operating voltage measurements should be larger than the time interval during which a particular driving scheme is applied.

The embodiments described so far can be combined with the use of predefined limits for the target voltage. For example, a range can be defined for allowed values of target voltage, so that, for instance, if the target voltage determined with one of the aforementioned methods exceeds the maximum allowed value, this maximum allowed value will be used instead. In the same way, if the determined target voltage is less that the lowest permissible value, this lowest value will be used instead. Furthermore, a span can be defined for the permissible target voltage values, i.e. it may be determined that the upper and lower target voltage values may not differ by more than a certain amount. In this way, it is ensured that the target voltage value does not lie outside the given range. Another implementation of predefined values could be to define a fixed difference between the target voltage and the maximum (or minimum) operating voltage during a certain time interval. For example, it may be required that the target voltage always remains 3 V below the maximum operating voltage observed during the previous hour. The predefined range or difference can be fixed over the lifetime of the lamp, but can also be varied with operating time. In this way, side-effects of the inevitable ageing of the lamp, such as electrode burn-back, can be compensated for, so that the lifetime of the lamp is increased. Applying limits for the target voltage in the approaches described above makes it possible to maintain the length of the discharge arc within limits that give acceptable light flux values for that lamp's application. The limits can be stored as appropriate values in the lamp driver, and can be updated as necessary.

A predefined range and/or span for the target voltage can also influence the arc length of a lamp so that a desired length is obtained. This may be useful in the situation that the initial arc length does not fulfil the requirements of the application, for reasons such as production spread. The actual arc length can be adapted to reach the desired value, for example by slowly ramping a predefined range of voltage targets up or down over a relatively long time period, such as 24 hours. This process can be repeated until the obtained arc length matches the desired arc length, or can be stopped after a certain number of unsuccessful trials. If the lamp is switched off while the ramp is still running, the status of the process can be stored in a memory of the lamp driver, and the process can be re-started in the next switching cycle.

Using any of the variations of the method according to the invention, as described above, the target voltage can be adapted as desired to suit the momentary requirements. If a new target voltage is determined that is considerably higher or lower than the momentary target voltage, it may be expedient to adapt the target voltage slowly, for example in stages over a certain length of time, such as five minutes, so that the discharge arc and therefore the light flux of the lamp are not subject to extreme changes.

Predefined parameters for controlling determination of the target voltage can also be used to specify a minimum or maximum step-change of the target voltage. When a maximum step-change is specified, the rate of change of the target voltage can be limited, as described in the previous paragraph. By using a minimum step-change, on the other hand, a too frequent adjustment of the target voltage can be avoided. For instance, if the new target voltage is too close to the old target voltage, i.e. the difference of the target voltages is less than the minimum step, no change will take place.

A driving unit according to the invention can include one or more lamp parameter observation units such as those employed in state of the art driving units for monitoring or observation of lamp values, or for counting predefined time intervals. Units that make decisions based on measured parameters, such as the target voltage determination unit and the driving scheme switching unit, may include hardware components such as processor chips upon which suitable software modules can be run. Any predefined values such as upper or lower target voltage limits, and observed values such as a series of operating voltage values, can be stored in a non-volatile memory so that these values are not lost when the lamp is switched off. The storage capacity of the non-volatile memory can be chosen according to the application for which the lamp is to be used. For example, it may suffice to store only a few values for a lamp that is only used for relatively short periods of time, such as a lamp in a projector system or an automobile headlight, where the running time is usually limited to a few hours. For applications in which the lamp runs for days, it may be preferable to use a large non-volatile memory so that operating voltage values can be collected and stored over long periods of time for optimal determination of the target voltage.

Evidently, the method and driving unit according to the invention could be applied to any application that makes use of a short-arc gas-discharge lamp as described, requiring a stable arc and constant light flux. Any existing state of the art driving unit for a short-arc gas-discharge lamp could conceivably be modified to allow the lamp to be driven using the method according to the invention. For example, with relatively little effort, software modules and/or hardware components could be replaced in or added to an existing projection system driving unit.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a simplified graph of operating voltage over time for a lamp driven according to a prior art method.

FIG. 2 shows a simplified graph of operating voltage over time for a lamp driven using the method according to the invention.

FIG. 3 shows a graph of operating voltage measured over time for a lamp driven using the method according to the invention.

FIG. 4 shows a gas-discharge lamp and a block diagram of a possible realisation of a driving unit according to the invention.

In the drawings, like numbers refer to like objects throughout. Objects in the diagrams are not necessarily drawn to scale.

### DETAILED DESCRIPTION OF THE EMBODIMENTS

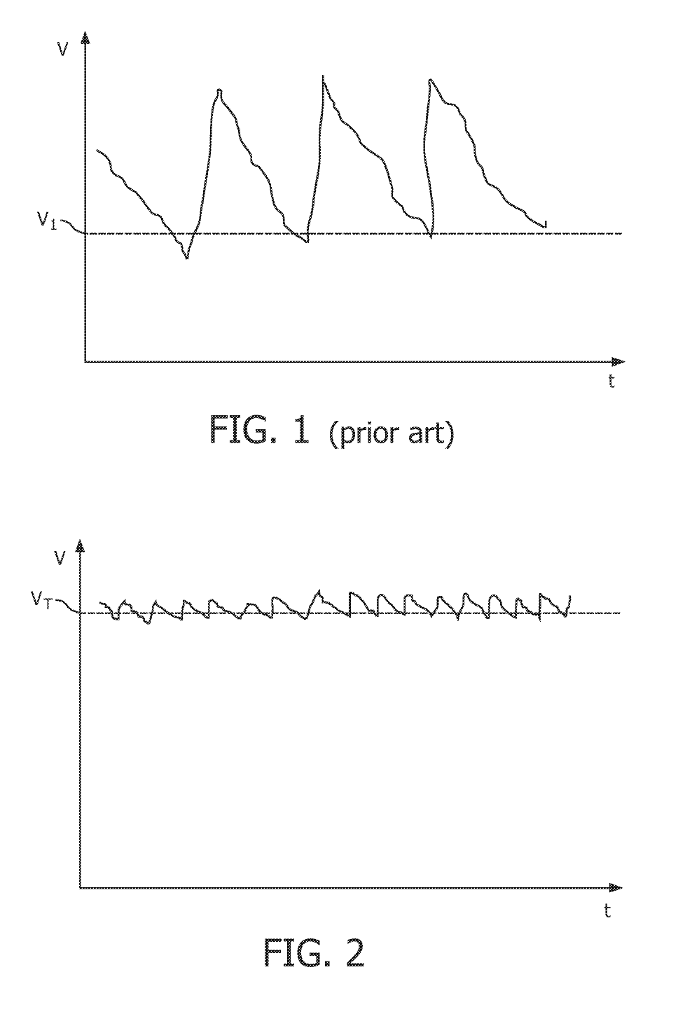

FIG. 1 shows a graph of operating voltage over time for a lamp driven according to a prior art method, such as that described in WO 2005/062684 A1, in which a predetermined target voltage V₁, indicated by the dashed line in the diagram, is used by the driver of the lamp to determine when to switch between driving schemes. Whenever the operating voltage crosses the target voltage V₁, the lamp driver triggers a driving scheme switch-over. If the operating voltage is too low, implying that the arc length is too short, a first driving scheme may be used in which the frequency of the lamp current can be sufficiently high so that the electrode tips melt back slightly. If the operating voltage is too high, implying that the arc length is too long, a second driving scheme may be used in which the lamp current wave shape includes a pulse that causes a tip to grow again on the front face of the electrode. By switching between driving schemes in this way, a stable discharge arc can be achieved. As long as the operating voltage actually reaches or crosses the value of target voltage, this method can work well. However, the operating voltage may not behave as predictably as desired, for the reasons already mentioned above. In the very simplified example shown, the overall operating voltage of the lamp exhibits a tendency to increase little by little until, eventually, it fails to cross the target voltage level. In the diagram shown, the operating voltage now oscillates above the predefined target voltage V₁. As a result, the lamp driver cannot trigger the desired changeovers between driving schemes. The operating voltage might continue to increase, for example until it reaches such a level that the lamp driver is forced to make a more radical correction. In the meantime, the light flux of the lamp may fluctuate undesirably, since the electrodes of the lamp may burn back further than desired, or tips may grow on the electrodes in an uncontrolled manner.

This undesirable situation is remedied by the method according to the invention, which may utilise a driving scheme management of WO 2005/062684 A1 described above, or a similar driving scheme, but allows a voltage target level for a lamp to be chosen to suit that particular lamp. Using any of the methods previously described for target voltage level calculation, a target voltage level is dynamically determined about which the lamp will tend to oscillate. This is shown in the simplified graph of FIG. 2 which shows operating voltage over time, and a target voltage level chosen so that the operating voltage reliably crosses the target value. This allows a more controlled growing and melting of the electrodes, and therefore results in a discharge arc of more constant length, so that a more stable light flux is maintained even over longer operation times of the lamp. As described above, the target voltage level can be adjusted as required during operation of the lamp, so that the lamp provides a steady light output even over very long time scales.

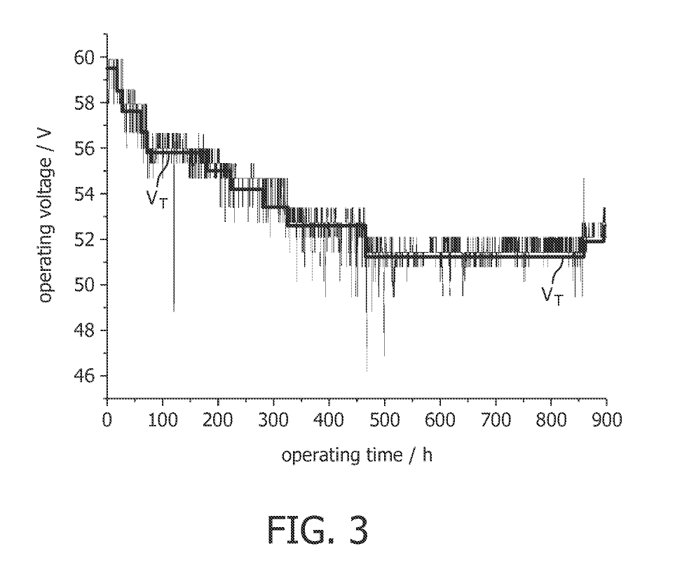

FIG. 3 shows actual measured values of operating voltage obtained over a long period of time (>900 hours) for a 110 W lamp driven using a method according to the invention, and with driving scheme switch-overs effected using the method disclosed in the European Patent Application EP 07112156. Here, the target voltage was determined by calculating an average or mean value of the operating voltage over time. The thick solid line, moving in steps across the voltage curve, indicates the target voltage level for this lamp, as adjusted by the lamp driver during operation of the lamp. As can be seen from the diagram, the target voltage is predominantly positioned at a level approximately corresponding to the mean of previous operating voltage values. As operating conditions in the lamp cause the operating voltage to exhibit phase-wise decreases or increases over time, the target voltage level essentially ‘follows’ these tendencies, i.e., when the operating voltage tends to an overall lower level, the target voltage level is adjusted accordingly by stepping it down. In the same way, when the operating voltage tends to an overall higher level, the target voltage level is adjusted accordingly by stepping it up. As a result of applying this method, it is ensured that the operating voltage reliably crosses the target voltage level, allowing switch-overs between operating modes to be triggered by the lamp driver, thus ensuring a steady light flux over time scales of several hours. Even though the operating voltage is subject to alterations over time, these are not apparent to a user in timescales of only a few hours, for example when the lamp is used in an application such as a projection system or an automobile headlight.

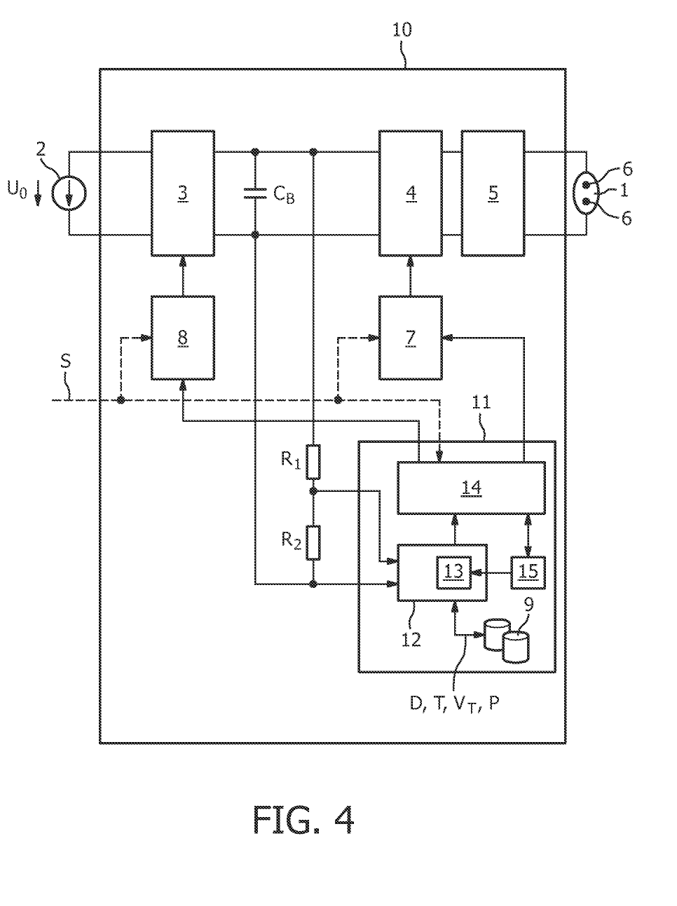

FIG. 4 shows a gas discharge lamp 1 and a block diagram of one embodiment of a driving unit 10 according to the invention. The system as shown can be used, for example, as part of a projection system.

The circuit shown comprises a power source 2 with which supply voltage U₀ of, for example, 380 Volt DC is made available to a down converter unit 3. The output of the down converter unit 3 is connected via a buffer capacitor C_{B} to a commutation unit 4, which in turn supplies an ignition stage 5 by means of which the lamp 1 is ignited and operated. When the lamp 1 is ignited, a discharge arc is established between the electrodes 6 of the lamp 1.

The frequency of the lamp current is controlled by a frequency generator 7, and the wave shape of the lamp current is controlled by a wave forming unit 8.

The voltage applied to the buffer capacitor C_{B} is additionally fed via a voltage divider R₁, R₂ to a voltage monitoring unit 12 in the control unit 11. The voltage monitoring unit 12 monitors the operating voltage of the lamp 1 to obtain an operation data value D. For instance, the operation data value can be the operating voltage measured every hour, or every five minutes, or after a certain time has elapsed after switch-on of the lamp, or at a certain time before the lamp is switched off. The rate at which an operation data value D is to be obtained can be given by timing parameters T stored in a memory 9, and a timer 15 or clock 15 supplies the necessary time signal.

The operation data value D, if it is to be used at a later stage, can also be stored in the memory 9. For example, if the target voltage for a subsequent operation of the lamp is to be based on the operating voltage of the lamp 1 prior to switch-off in the present operation, the operating voltage of the lamp 1 is measured at the relevant instant in time and then stored as a value of target voltage in the memory, where it can be retrieved the next time the lamp 1 is switched on.

A target voltage determination unit 13, shown as part of the voltage monitoring unit 12, decides which value is to be used as a future target voltage V_{T}. The manner in which the target voltage is to be determined, for example the algorithm to be used, can also be predetermined and stored in the memory 9. In a simple version, the target voltage determination unit 13 decides that an operation data value D obtained at a certain time is to be used as the target voltage V_{T}. In a more complex version, the target voltage determination unit 13 uses a series of previously obtained and stored operation data values D to obtain a corrected target voltage V_{T}. The target voltage V_{T} can be supplied in appropriate signal form, for example in the form of a binary sequence, to the control unit 11. Other parameters P, for example predetermined limits for upper and lower voltage levels, can also be obtained from the memory 9 and used by the target voltage determination unit 13 in its calculation.

An operating mode switching unit 14 decides on the operation mode and frequency with which the lamp 1 is to be driven at any one time, and supplies appropriate signals to the frequency generator 7, which drives the commutation unit 4 at the appropriate frequency, and to the wave-shaping unit 8, which, using the down converter 3, ensures that the correct current/pulse wave shape is generated for the desired driving scheme or operation mode. The decision to switch from one driving scheme to the next is based on the operating voltage monitored by the voltage divider R₁, R₂ and a value of target voltage V_{T} stored in a memory 9. Possible driving scheme parameters (wave shape, frequency etc.) are described in WO 2005/062684 A1.

When the driving unit 10 shown is used in a projection system, a synchronisation signal S is supplied from an external source (not shown) to the driving unit 10, and is distributed to the frequency generator 7, the wave-shaping unit 8 and the control unit 11, so that the lamp driver 10 can operate synchronously with, for example, a display unit or a colour generation unit of the projection system.

In the diagram, the memory 9, the operating mode switching unit 14, the voltage monitoring unit 12, the target voltage determination unit 13, and the timer 15 are all shown as part of the control unit 11. Evidently, this is only an exemplary illustration, and these units could be realised separately if required.

The control unit 11 or at least parts of the control unit 11, such as the operating mode switching unit 14 or target voltage determination unit 13, can be realised as appropriate software that can run on a processor of the driving unit 10. This advantageously allows an existing lamp driving unit to be upgraded to operate using the method according to the invention, provided that the driving unit is equipped with the necessary wave-shaping unit and frequency generator. The driving unit 10 is preferably also equipped with a suitable interface (not shown in the diagram) so that an initial target voltage and any other desired parameters can be loaded into the memory 9 at time of manufacture or at a later time, for example when a different lamp type is substituted or a different performance is desired.

The invention can preferably be used with all types of short-arc HID-lamps that can be driven with the method described above in applications requiring a stable arc (both axial and lateral). Although the present invention has been disclosed in the form of preferred embodiments and variations thereon, it will be understood that numerous additional modifications and variations could be made thereto without departing from the scope of the invention. It is also conceivable that a lamp driver could manage several different target voltages for a lamp, and can apply a particular target voltage according to the conditions under which the lamp is being driven at any one time. Each of these target voltages can be determined using any of the methods described above.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

### LIST OF REFERENCE SIGNS

1 gas-discharge lamp
2 power supply
3 down converter
4 commutation unit
5 ignition stage
6 electrodes
7 frequency generator
8 wave-shaping unit
9 memory
10 driving unit
11 control unit
12 voltage monitoring unit
13 target voltage determination unit
14 operating mode decision unit
15 timer
V₁ target voltage
V_{T} target voltage
R₁ resistor
R₂ resistor
C_{B} buffer capacitor
D operation data value
P parameters
T timing parameters
S synchronisation signal

1. A method of driving a gas-discharge lamp, wherein the lamp is driven at any one time using one of a number of driving schemes and wherein
the operating voltage of the lamp is monitored to obtain a number of operation data values (D) during operation of the lamp, and
a target voltage (V_{T}) is determined on the basis of at least one of the number of operation data values (D),
and a driving scheme switch-over occurs according to a relationship between the target voltage (V_{T}) and the operating voltage of the lamp.

2. A method according to claim 1, wherein a driving scheme switch-over occurs when the operating voltage crosses the target voltage (V_{T}).

3. A method according to claim 1, wherein an operation data value (D) is obtained at a predefined point in time during operation of the lamp.

4. A method according to claim 1, wherein a plurality of operation data values (D) are obtained during operation of the lamp, and the target voltage (V_{T}) is dynamically adjusted according to the obtained operation data values (D).

5. A method according to claim 4, wherein the target voltage (V_{T}) is derived from an average of a plurality of operation data values.

6. A method according to claim 4, wherein the target voltage (V_{T}) is derived from a combination of the previous target voltage (V_{T}) and an operation data value (D).

7. A method according to claim 1 wherein the operation data value (D) obtained at a point in time comprises the operating voltage of the lamp at that point in time.

8. A method according to claim 1, wherein an upper limit and/or a lower limit is defined for the target voltage (V_{T}).

9. A method according to claim 1, wherein a target voltage (V_{T}) is determined prior to switching off the lamp, and this target voltage (V_{T}) is stored in a non-volatile memory for use in a subsequent operation of the lamp.

10. A driving unit for driving a gas-discharge lamp comprising
a voltage monitoring unit for monitoring the operating voltage of the lamp to obtain a number of operation data values (D) during operation of the lamp;
a target voltage determination unit for determining a target voltage (V_{T}) on the basis of at least one of the number of operation data values (D);
a driving scheme switching unit for switching from a first driving scheme to a second driving scheme according to a relationship between the target voltage (V_{T}) and the operating voltage of the lamp.

11. A projection system comprising a gas-discharge lamp and a driving unit (4) according to claim 10.

12. A method according to claim 1, wherein an operation data value (D) is obtained after a predefined time has elapsed after switching on the lamp.

13. A method according to claim 1, wherein an operation data value (D) is obtained at a predefined time before the lamp is switched off.
